(19) United States
(12) Patent Application Publication
(10) Pub. No.: US 2006/0253710 A1
(43) Pub. Date: Nov. 9, 2006

(54) Biometric information recognition credit card system and credit card scanner

(76) Inventor: Hong-Sik Koo, Seoul (KR)

Correspondence Address: IPLA P.A., 3580 WILSHIRE BLVD., 17TH FLOOR, LOS ANGELES, CA, 90010, US

(21) Appl. No.: 10/552,690

(22) PCT Filed: Feb. 25, 2004
(86) PCT No.: PCT/KR04/00386

§ 371 Date: Oct. 11, 2005

(30) Foreign Application Priority Data
Feb. 25, 2003 (KR) 10-2003-0011595

(51) Int. Cl. H04K 1/00

(52) U.S. Cl. 713/186

(57) ABSTRACT

The present invention relates to a biometric information recognition credit card system and credit card scanner. The biometric information of a credit card holder is scanned when using a credit card. The scanned biometric information is compared with separately stored biometric information. A part of the biometric information may be stored in the credit card. A credit card scanner transmits the biometric information and credit card information to a server only when the part of the biometric information stored in the credit card and the part of the scanned biometric information are identical with each other. A separated biometric information management center separately stores the biometric information of each credit card holder. When the separately stored biometric information and the scanned biometric information are identical with each other, the use of the credit card is approved.

### TECHNICAL FIELD

The present invention relates, in general, to a biometric information recognition credit card system and credit card scanner and, more particularly, to a biometric information recognition credit card system that, after separately storing biometric information in a plurality of locations, scans the biometric information of a credit card holder at the time of using a credit card, and approves the use of the credit card only when the scanned biometric information is identical with the previously stored biometric information, and a credit card scanner that is used in the biometric information recognition credit card system.

### BACKGROUND ART

The transactions of properties using credit cards are widely used because they are advantageous in that there is no need to carry cash and transaction details are transparent, but they are problematic in that transaction accidents frequently occur due to the illegal reproduction of credit cards or the stealing of credit card information.

In order to solve the problem, in Korean Unexamined Pat. Publication No. 2002-0033274 and Korean Utility Model No. 0279242, the biometric information of a credit card holder, such as a fingerprint image or an iris image, is previously stored in a credit card or a server, the biometric information of the credit card holder is read whenever the credit card is used, and the read biometric information is compared to the previously stored biometric information.

If these schemes are used, some other person can be prevented from stealing and illegally using the credit card, but there is a disadvantage in that the illegal use of a credit card may not be prevented in the case where the biometric information stored in the credit card or the server is hacked or stolen.

### BRIEF DESCRIPTION OF THE DRAWINGS

FIGS. 1a and 1b are views showing the entire construction of a biometric information recognition credit card system according to the present invention, which illustrate the case where a separated biometric information management center is connected to a credit card network, such as a Value Added Network (VAN), and the case where the separated biometric information management center is connected to a credit card company server, respectively;

FIG. 2 is a block diagram showing the internal construction of a credit card scanner;

FIG. 3 is a flowchart showing an operation performed by the credit card scanner when the credit card scanner separates and transmits biometric information;

FIG. 4a is a view showing the operation performed by the biometric information recognition credit card system based on the embodiment of FIG. 3, and FIGS. 4b and 4c are views showing the operations performed between the separated biometric information management center and separated biometric information storage servers when biometric information is separately stored in the separated biometric information storage servers;

FIG. 5 is a view showing the operation of the credit card system according to a modified embodiment of FIG. 4;

FIG. 6 is a view showing the operation of the credit card system when biometric information scanned through the credit card scanner is not separated; and

FIG. 7 is a view showing the operation of the credit card system according to an embodiment in which the biometric information, separately stored in the separated biometric information management center, and the biometric information, separately stored in a credit card, are combined and restored into original biometric information, and then the original biometric information is compared to the biometric information of a credit card holder.

### DETAILED DESCRIPTION OF THE PRESENT INVENTION

Technical Problem

Accordingly, the present invention has been made keeping in mind the above problems occurring in the prior art, and an object of the present invention is to provide a credit card system and credit card scanner, which separately stores biometric information, so that illegal use of a credit card can be prevented even though a part of the stored biometric information is hacked.

Technical Solution

In order to accomplish the above object, the present invention provides a biometric information recognition credit card system, comprising a plurality of credit cards each storing therein credit card information including a credit card number; a plurality of credit card scanners each having a keypad adapted to input sales details, a card information input unit adapted to read credit card information from each of the credit cards, a biometric information input unit adapted to read biometric information of each of credit card holders, a sales slip output unit adapted to output a sales slip, a communication unit adapted to transmit/receive data to/from credit card company servers, a display unit adapted to display various pieces of information, and a control unit adapted to separate biometric information input from the biometric information input unit and transmit separated biometric information to a separated biometric information management center through the communication unit, to transmit sales information input through the keypad and the credit card information provided from the credit card to a corresponding credit card company server through the communication unit, and to control the sales slip output unit to output a sales slip on the basis of authentication results, provided from the credit card company server, and biometric information authentication results, provided from the separated biometric information management center; one or more credit card company servers each transmitting data indicating whether to approve use of each of the credit cards to a corresponding credit card scanner depending on authentication results of the credit card information received from the credit card; and the separated biometric information management center separately storing therein biometric information of each of credit card holders, comparing separated biometric information received from the credit card scanner with the separately stored biometric information when receiving the separated biometric information, and transmitting the biometric information authentication results depending on whether the received biometric information is identical with the separately stored biometric information.

Further, each of the credit cards may store therein a part of biometric information of each of the credit card holders, and each of the credit card scanners may transmit the separated biometric information, the sales information, and the credit card information only when the part of the biometric information stored in the credit card is identical with a corresponding part of the separated biometric information. Further, if each of the credit card scanners transmits the part of the biometric information stored in the credit card together with the separated biometric information to the separated biometric information management center, the separated biometric information management center may compare the separated biometric information received from a corresponding credit card scanner with both the part of the biometric information stored in the credit card and the biometric information separately stored in the separated biometric information management center.

The separated biometric information management center may be connected to a plurality of separated biometric information storage servers storing therein the parts of the separated biometric information of each of the credit card holders. The comparison of biometric information may be performed on the basis of the parts of the separated biometric information, or pieces of original biometric information after the parts of the separated biometric information are restored into the original biometric information.

The separated biometric information management center may communicate with the credit card scanners through the credit card company servers, or directly communicate with the credit card company servers.

The biometric information scanned from each of the credit card holders may be transmitted after being separated in the credit card scanner, or transmitted to the separated biometric information management center without change and then separated and compared thereby.

Further, each of the credit card scanners may receive the parts of the separately stored biometric information from the separated biometric information management center, combine the parts of the separately stored biometric information into original biometric information, compare the original biometric information with the input biometric information of the credit card holder, and inquire of a corresponding credit card company server whether the use of the credit card is approved when the two pieces of biometric information are identical with each other.

### BEST MODE FOR CARRYING OUT THE INVENTION

Hereinafter, embodiments of the present invention will be described in detail with reference to the attached drawings.

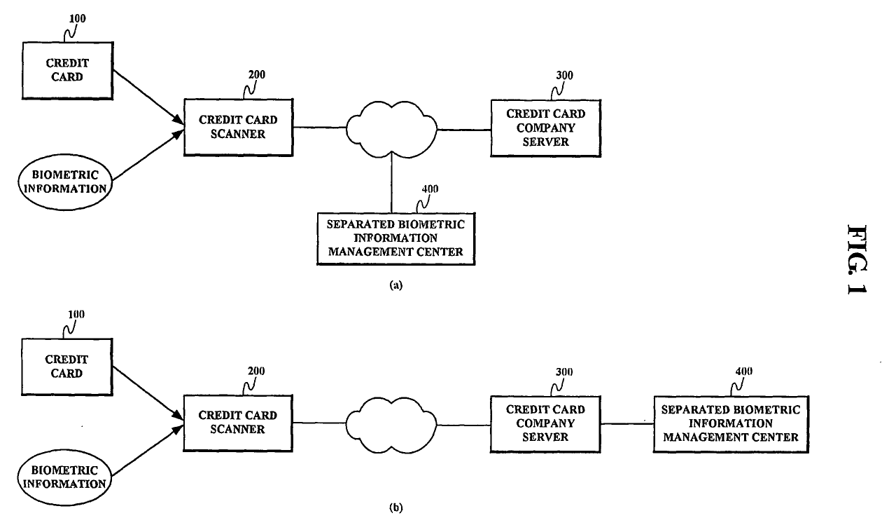

FIGS. 1a and 1b are views showing the entire construction of a biometric information recognition credit card system according to the present invention, which illustrate the case where a separated biometric information management center 400 is connected to a credit card network, such as a Value Added Network (VAN), and the case where the separated biometric information management center 400 is connected to a credit card company server 300, respectively.

In the present invention, when a credit card 100 is used, information recorded in the credit card 100 is read and the biometric information of a credit card holder, such as a fingerprint image or an iris image, is input through the use of a credit card scanner 200. The credit card 100 may store therein a part of the biometric information of the credit card holder, as well as typical information recorded in the credit card. Moreover, the credit card 100 may include a debit card, electronic money, etc., as well as typical credit cards. Further, any shapes of the credit card using media capable of storing credit card information, such as an RF chip or a smart chip, as well as the shape of a typical magnetic tape, can be used in the shape of the credit card 100. Further, a mobile phone, a Personal Digital Assistant (PDA) or the like that includes the above media and has the function of a credit card may be included in the credit card 100 of the present invention.

The credit card scanner 200 not only transmits input credit card information and sales information to the credit card company server 300, similar to the conventional credit card scanner 200, but also transmits input biometric information without change, or separates the input biometric information depending on a predetermined rule and transmits the separated biometric information to the separated biometric information management center 400. If the separated biometric information management center 400 is connected to the credit card company server 300, as shown in FIG. 1b, biometric information is transmitted to the separated biometric information management center 400 through the credit card company server 300.

In the meantime, if a part of the biometric information of the credit card holder is stored in the credit card, the credit card scanner 200 can be adapted to separate the input biometric information, compare the separated biometric information with the part of the biometric information stored in the credit card, and transmit credit card information, sales information and biometric information only when the separated biometric information and the part of the stored biometric information are identical with each other.

The separated biometric information management center 400 stores a plurality of parts of the separated biometric information, into which the biometric information of each of credit card holders is separated, in a plurality of storage media, respectively. The plurality of storage media may be storage media provided within the separated biometric information management center 400, or storage media that are distributed in a plurality of servers connected to the separated biometric information management center 400 through a communication network. Further, the separated biometric information management center 400 preferably has a list holding the locations in which biometric information is separately stored with respect to each of the credit card holders. In the meantime, if a part of the biometric information is stored in the credit card, the separated biometric information management center 400 may store the remaining parts of the biometric information in a single location, or may separately store the remaining parts of the biometric information in a plurality of locations.

If biometric information is transmitted to the separated biometric information management center 400 without being separated by the credit card scanner 200, the separated biometric information management center 400 separates the received biometric information. The parts of the separated biometric information are compared to the parts of the biometric information, separately stored in the plurality of storage media, by the separated biometric information management center 400.

The comparison results of the biometric information are transmitted to the credit card company server 300. The construction of the credit card company server 300 is almost identical with that of a conventional credit card company server 300, but it is different from the conventional credit card company server 300 in that the credit card company server refers to the biometric information comparison results provided from the separated biometric information management center 400 at the time of approving the use of a credit card according to the embodiments.

The credit card company server 300 approves or denies the use of the credit card on the basis of credit card authentication results and biometric information comparison results. Further, at the time of denying the use of the credit card, the credit card company server 300 may indicate whether the denial is due to the credit card authentication results or the biometric information comparison results, and transmit the indication to the credit card scanner 200.

Further, the biometric information comparison results may be directly transmitted from the separated biometric information management center 400 to the credit card scanner 200. In this case, the credit card scanner 200 outputs a sales slip on the basis of the biometric information comparison results provided from the separated biometric information management center 400 and credit card approval results provided from the credit card company server 300.

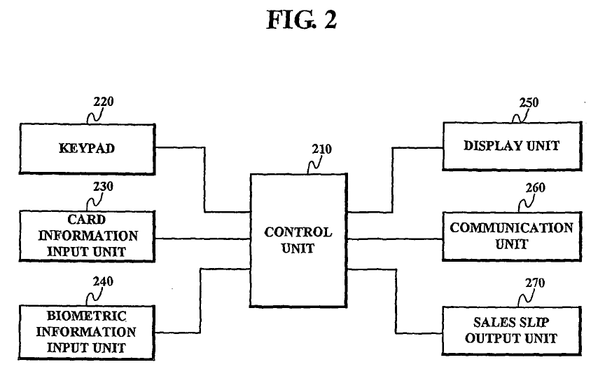

Next, with reference to FIG. 2, the internal construction of the credit card scanner 200 of the present invention is described. FIG. 2 is a block diagram showing the internal construction of the credit card scanner 200.

The credit card scanner 200 includes a keypad 220 adapted to input sales details, a card information input unit 230 adapted to read information recorded in the magnetic tape or smart chip of a credit card, a display unit 250 adapted to display input contents and authentication results, a communication unit 260 adapted to communicate with the credit card company server, and a sales slip output unit 270 adapted to output a sales slip based on the use of the credit card, similar to a typical credit card scanner. Further, the credit card scanner 200 of the present invention includes a biometric information input unit 240 adapted to scan the biometric information of a credit card holder, such as a fingerprint image or an iris image.

A control unit 210 transmits biometric information received from the biometric information input unit 240 to the separated biometric information management center 400 through the communication unit 260, transmits both sales information input through the keypad 220 and the credit card information input from the credit card 100 to the credit card company server 300 through the communication unit 260, and controls the sales slip output unit 270 to output a sales slip on the basis of authentication results provided from the credit card company server 300 and biometric information authentication results provided from the separated biometric information management center 400. Further, the control unit 210 may separate biometric information before transmitting the biometric information.

In the meantime, the credit card scanner 200 may receive biometric information from the separated biometric information management center 400 and compare the received biometric information with previously stored biometric information, in place of transmitting the biometric information scanned by the credit card scanner 200 to the separated biometric information management center 400, according to embodiments.

Further, in case of a mobile phone equipped with a biometric recognition function and a credit card function, the mobile phone may be adapted to perform both the functions of the credit card 100 and the credit card scanner 200.

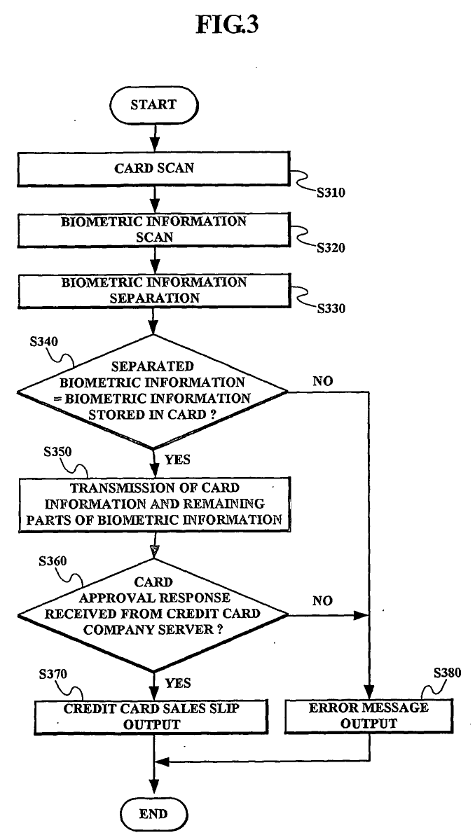

The operation of the credit card scanner 200 having the above construction is described in detail with reference to FIG. 3. FIG. 3 is a flowchart showing the operation performed by the credit card scanner when the credit card scanner separates and transmits biometric information.

First, the credit card scanner 200 reads information stored in the credit card 100 through the use of the card information input unit 230 at step S310. At this time, the credit card scanner 200 reads a part of the biometric information stored in the credit card 100 together with the credit card information. Next, the credit card scanner 200 reads the biometric information of a credit card holder through the use of the biometric information input unit 240 at step S320. It does not matter if the sequence of these two steps is reversed.

The control unit 210 separates the scanned biometric information depending on a certain rule at step S330. The technology related to the separation of biometric information is disclosed in Korean Pat. Appl. No. 2002-0037900 filed by the present applicant, but the present invention is not limited to a specific biometric information separation method.

The control unit 210 compares the separated biometric information with a part of the biometric information read from the credit card 100 at step S340, outputs an error message through the display unit 250 if the two pieces of biometric information are not identical with each other at step S380, and transmits the read credit card information and the remaining parts of the separated biometric information except for the part of the biometric information compared at step S340 if the two pieces of biometric information are identical with each other at step S350. If the separated biometric information management center 400 is connected to the network independently from the credit card company server 300, as shown in FIG. 1a, the control unit 210 transmits the biometric information to the separated biometric information management center 400 and card information to the credit card company server 300.

After transmitting both the biometric information and the card information, the credit card scanner 200 waits for the approval response for the credit card to be received from the credit card company server 300 at step S360. If the separated biometric information management center 400 is connected to the network independently from the credit card company server 300, as shown in FIG. 1a, the credit card scanner 200 may separately receive the approval response for the credit card and the biometric information authentication results, and then determine the approval or denial of the use of the credit card.

If the approval of the use of the credit card is received from the credit card company server 300 within a certain period, the credit card scanner 200 outputs a sales slip for the credit card at step S370; otherwise it outputs an error message at step S380.

In the meantime, the credit card scanner 200 may be adapted to directly transmit both the input biometric information and card information to the credit card company server 300 by omitting step S340.

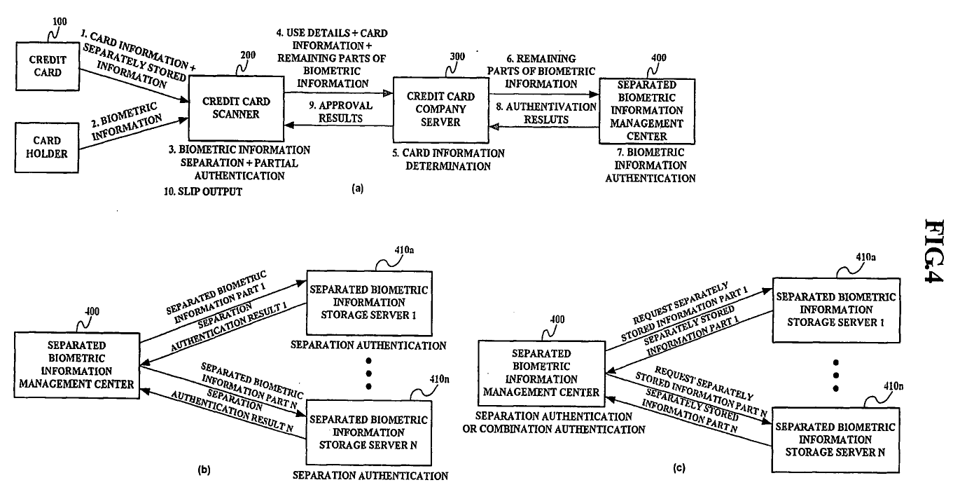

Next, the operation of the biometric information recognition credit card system according to an embodiment of the present invention is described in detail with reference to FIG. 4. FIG. 4a is a view showing the operation performed by the biometric information recognition credit card system based on the embodiment of FIG. 3, and FIGS. 4b and 4c are views showing the operations performed between the separated biometric information management center 400 and separated biometric information storage servers when the biometric information is separately stored in the separated biometric information storage servers.

First, the operation of the credit card system performed at the time of authenticating a credit card is described with reference to FIG. 4a.

1. The credit card system reads card information and separately stored biometric information from the credit card 100. In the credit card 100, a part of the biometric information obtained by separating the biometric information of the credit card holder depending on a predetermined rule is stored in advance. The credit card scanner 200 reads the card information, stored in the credit card 100, and the part of the biometric information, which is separately stored in the credit card 100, at the time of using the credit card.

2. The credit card scanner 200 scans the biometric information of the credit card holder.

3. The credit card scanner 200 separates the scanned biometric information of the credit card holder depending on a rule identical with the above-described rule. Further, the credit card scanner 200 ascertains whether the separated biometric information is identical with the biometric information separately stored in the credit card 100.

4. If the separated biometric information is identical with the biometric information separately stored in the credit card 100, the credit card scanner 200 transmits to the credit card company server 300 the details of use of the credit card input using the keypad, the card information stored in the credit card 200, and the remaining parts of the separated biometric information scanned from the credit card holder.

5. The credit card company server 300 determines whether the corresponding credit card is available on the basis of the received card information.

6. If the credit card is available, the credit card company server 300 transmits the received remaining parts of the biometric information to the separated biometric information management center 400. Further, the credit card system may be adapted to omit step 5, directly transmit the biometric information to the separated biometric information management center 400, receive results indicating that the two pieces of biometric information are identical with each other from the separated biometric information management center 400, ascertains the card information, and approve the use of the credit card.

7. The separated biometric information management center 400 compares the separately stored biometric information with the received remaining parts of the biometric information, and ascertains whether the two pieces of biometric information are identical with each other.

8. The separated biometric information management center 400 transmits the biometric information comparison results to the credit card company server 300.

9. The credit card company server 300 determines whether to approve the use of the corresponding credit card on the basis of the biometric information comparison results and the credit card authentication results provided from the credit card company server 300, and then transmits the approval results to the credit card scanner 200.

10. The credit card scanner 200 output a sales slip depending on the approval results received from the credit card company server 300.

In the above description, the case where the separated biometric information management center 400 is connected to the credit card company server 300 is described. However, the credit card system may be adapted so that the separated biometric information management center 400 is connected to the network independently from the credit card company server 300, as shown in FIG. 1a. In this case, the remaining parts of the biometric information received from the credit card scanner 200 are directly transmitted to the separated biometric information management center 400. Further, the authentication results provided from the separated biometric information management center 400 can be directly transmitted to the credit card scanner 200 without passing through the credit card company server 300.

In the meantime, the separated biometric information management center 400 may be connected to a plurality of separated biometric information storage servers. The plurality of separated biometric information storage servers separately store therein the parts of the separated biometric information. FIGS. 4b and 4c are views showing the operations performed in this case between the separated biometric information management center 400 and a plurality of separated biometric information storage servers 410a to 410n.

FIG. 4b shows the case where the separated biometric information management center 400 transmits the parts of the separated biometric information to the separated biometric information storage servers 410a to 410n storing corresponding parts of the biometric information, respectively, and the separated biometric information storage servers compare the parts of the separated biometric information with the corresponding parts of the biometric information, respectively, to perform biometric information authentication, and transmit the authentication results to the separated biometric information management center 400.

FIG. 4c shows the case where, if the management center 400 requests the separated biometric information storage servers, storing the parts of the biometric information corresponding to the parts of the separated biometric information, to transmit the parts of the biometric information, the respective separated biometric information storage servers transmit the parts of the biometric information stored therein, respectively, to the separated biometric information management center 400, and the separated biometric information management center 400 compares these parts of the biometric information with the parts of the separated biometric information received from the credit card scanner, respectively, or combines the parts of the biometric information and the parts of the separated biometric information into respective pieces of combined biometric information, and then compares the pieces of combined biometric information with each other, thus performing biometric information authentication.

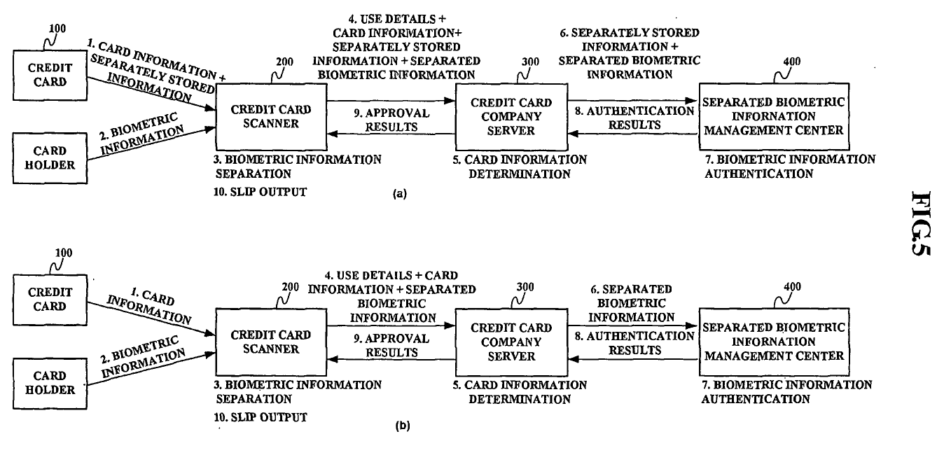

FIGS. 5a and 5b illustrate other embodiments of FIG. 4, which show the operational flow when step S340 of FIG. 3 is omitted, and the operational flow when a part of the biometric information of a credit card holder is not stored in the credit card, respectively. Meanwhile, even in this case, the separated biometric information management center 400 may be connected to a plurality of separated biometric information storage servers, as shown in FIGS. 4a to 4c.

Unlike FIG. 4a, in FIG. 5a, an authentication using the comparison of a part of the biometric information stored in the credit card with a part of the biometric information, which is scanned and separated, is not performed at step 3. Accordingly, the biometric information stored in the credit card is transmitted at steps 4 and 6. Since other procedures of FIG. 5a are identical with those of FIG. 4a, a detailed description thereof is omitted.

In FIG. 5b, the separately stored biometric information of a credit card holder is not read from the credit card at step 1. Therefore, an authentication procedure using the comparison of biometric information stored in the credit card with a separated part of the scanned biometric information is omitted at step 3, and other procedures of FIG. 5b are identical with those of FIG. 4a.

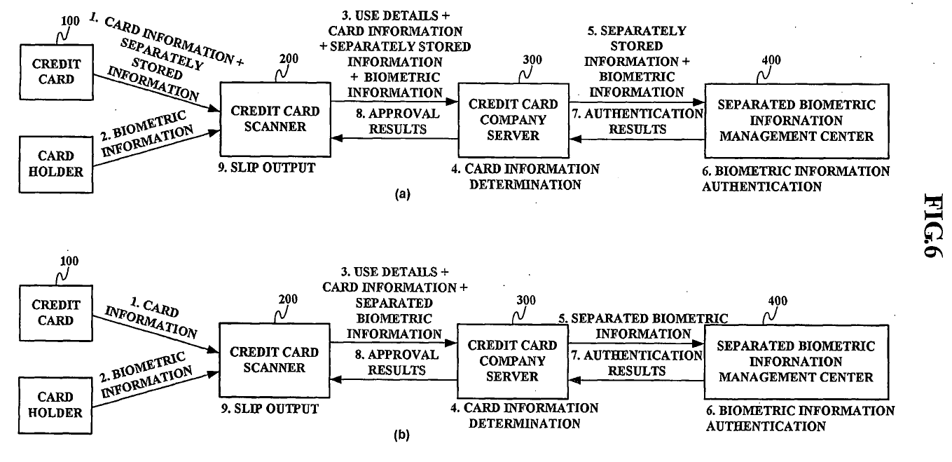

Next, other embodiments of the present invention are described with reference to FIGS. 6a and 6b. In these embodiments, if biometric information scanned by the credit card scanner 200 is transmitted without being separated, the separated biometric information management center 400 authenticates the received biometric information. For an authentication method for biometric information performed by the separated biometric information management center 400, there is a method of separating the biometric information received from the credit card scanner 200 through the separated biometric information management center 400 and comparing the parts of the separated biometric information with the parts of the biometric information, separately stored in the separated biometric information management center 400 or a plurality of separated biometric information storage servers. Further, there is a method of restoring the parts of the biometric information, separately stored in the separated biometric information management center 400 or the plurality of separated biometric information storage servers, into original biometric information and comparing the original biometric information with the received biometric information.

FIG. 6a shows the case where a part of the biometric information of a credit card holder is stored in the credit card 100, and FIG. 6b shows the case where a part of the biometric information of the credit card holder is not stored.

First, the operation of the credit card system, performed at the time of authenticating the credit card when a part of biometric information of the credit card holder is stored in the credit card 100, is described with reference to FIG. 6a.

1. The credit card scanner 200 reads both the card information and separately stored biometric information from the credit card 100.

2. The credit card scanner 200 scans the biometric information of a credit card holder.

3. The credit card scanner 200 transmits the details of use of the credit card, input using the keypad, the card information and separate biometric information, stored in the credit card 100, and the biometric information scanned from the credit card holder, to the credit card company server 300.

4. The credit card company server 300 ascertains whether a corresponding credit card is available on the basis of the received card information.

5. If the credit card is available, the credit card company server 300 transmits both the scanned biometric information and the biometric information stored in the credit card to the separated biometric information management center 400. The credit card system may be adapted to omit step 4 and to directly transmit the biometric information to the separated biometric information management center 400, receive the results indicating that the two pieces of biometric information are identical with each other from the separated biometric information management center 400, ascertains the card information, and approve the use of the credit card.

6. The separated biometric information management center 400 compares the biometric information separately stored therein, with the scanned biometric information, and then ascertains whether the two pieces of biometric information are identical with each other. At this time, procedures described in FIGS. 4b and 4c can be performed. However, there is a difference in that the separated biometric information stored in the credit card 100 is further used. Further, the credit card system may be constructed so that the separated biometric information stored in the credit card 100 and the biometric information stored in the separated biometric information management center 400 are combined and restored into original biometric information and then the original biometric information is compared to the scanned biometric information received from the credit card scanner 200.

7. The separated biometric information management center 400 transmits the biometric information comparison results to the credit card company server 300.

8. The credit card company server 300 determines whether to approve the use of the corresponding credit card on the basis of the biometric information comparison results and the credit card authentication results provided from the credit card company server 300, and then transmits the approval results to the credit card scanner 200.

9. The credit card scanner 200 output a sales slip depending on the approval results received from the credit card company server 300.

In FIG. 6b, the authentication of a credit card is performed through a procedure similar to that of FIG. 6a except for the fact that biometric information separately stored in the credit card is not transmitted to the separated biometric information management center 400 because a part of the biometric information of the credit card holder is not stored in the credit card.

In the above description, the case where the separated biometric information management center 400 is connected to the credit card company server 300 is described. However, the credit card system may be constructed so that the separated biometric information management center 400 is connected to the network independently from the credit card company server 300, as shown in FIG. 1a. In this case, the remaining parts of the biometric information received from the credit card scanner 200 are directly transmitted to the separated biometric information management center 400. Further, the authentication results provided from the separated biometric information management center 400 can be directly transmitted to the credit card scanner 200 without passing through the credit card company server 300.

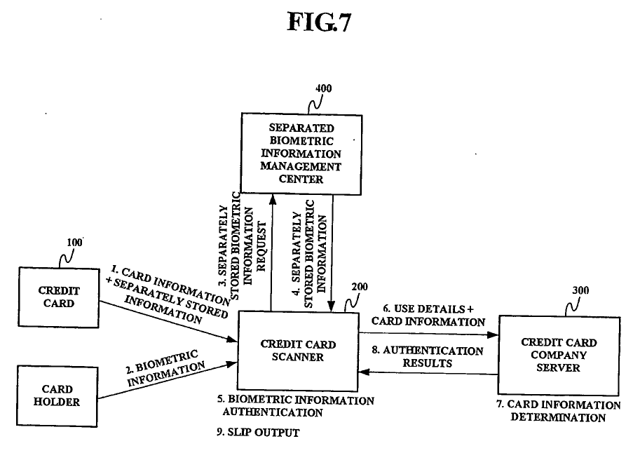

Next, with reference to FIG. 7, there will be described an embodiment in which biometric information, separately stored in the separated biometric information management center, and biometric information, separately stored in the credit card, are combined and restored into original biometric information by the credit card scanner, and the original biometric information is compared with the biometric information scanned from the credit card holder.

1. The credit card scanner 200 reads both the card information and separately stored biometric information from the credit card 100.

2. The credit card scanner 200 scans the biometric information of the credit card holder.

3. The credit card scanner 200 requests the biometric information of the corresponding credit card holder, separately stored in the separated biometric information management center 400.

4. The separated biometric information management center 400 transmits the parts of the biometric information of the corresponding credit card holder stored therein to the credit card scanner 200.

5. The credit card scanner 200 combines a part of the biometric information, stored in the credit card 100, with the parts of the biometric information, stored in the separated biometric information management center 400, restores the combined results into original biometric information, and compares the original biometric information with the biometric information scanned at step 2 to perform biometric information authentication.

6. As a result of the comparison and authentication, if the two pieces of biometric information are identical with each other, the credit card scanner 200 transmits the details of use of the credit card, input using the keypad and the card information stored in the credit card 100, to the credit card company server 300.

7. The credit card company server 300 ascertains whether the corresponding credit card is available and whether used money is within the credit limit of the corresponding user on the basis of the received card information.

8. The credit card company server 300 determines whether to approve the use of the corresponding credit card depending on the ascertained results, and transmits the approval results to the credit card scanner 200.

9. The credit card scanner 200 outputs a sales slip depending on the approved results received from the credit card company server 300.

Hereinbefore, the present invention is described with reference to several examples, however it is not limited to specific embodiments. Those skilled in the art will appreciate that various modifications, additions and substitutions are possible, without departing from the scope and spirit of the invention as disclosed in the accompanying claims.

### INDUSTRIAL APPLICABILITY

As described above, the present invention provides a credit card system and credit card scanner, which separates biometric information and stores the separated biometric information in a plurality of locations, so that the illegal use of a credit card can be prevented even though a part of the stored biometric information is hacked.

1. A biometric information recognition credit card system, comprising:
a plurality of credit cards each storing therein credit card information including a credit card number;
a plurality of credit card scanners each having a keypad adapted to input sales details, a card information input unit adapted to read credit card information from each of the credit cards, a biometric information input unit adapted to read biometric information of each of credit card holders, a sales slip output unit adapted to output a sales slip, a communication unit adapted to transmit/receive data to/from credit card company servers, a display unit adapted to display various pieces of information, and a control unit adapted to separate biometric information input from the biometric information input unit and transmit separated biometric information to a separated biometric information management center through the communication unit, to transmit sales information input through the keypad and the credit card information provided from the credit card to a corresponding credit card company server through the communication unit, and to control the sales slip output unit to output a sales slip on the basis of authentication results, provided from the credit card company server, and biometric information authentication results, provided from the separated biometric information management center;
one or more credit card company servers each transmitting data indicating whether to approve use of each of the credit cards to a corresponding credit card scanner depending on authentication results of the credit card information received from the credit card; and
the separated biometric information management center separately storing therein biometric information of each of credit card holders, comparing separated biometric information received from the credit card scanner with the separately stored biometric information when receiving the separated biometric information, and transmitting the biometric information authentication results depending on whether the received biometric information is identical with the separately stored biometric information.

2. The biometric information recognition credit card system according to claim 1, wherein:
the credit cards each store therein a part of biometric information of each of the credit card holders; and
the credit card scanners each transmits the separated biometric information, the sales information, and the credit card information only when the part of the biometric information stored in the credit card is identical with a corresponding part of the separated biometric information.

3. The biometric information recognition credit card system according to claim 2, wherein the credit card scanners each transmits remaining parts of the separated biometric information except for the corresponding part.

4. The biometric information recognition credit card system according to claim 1, wherein:
the credit cards each store therein a part of biometric information of each of the credit card holders; and
the credit card scanners each transmit the part of the biometric information stored in the credit card together with the separated biometric information to the separated biometric information management center.

5. The biometric information recognition credit card system according to claim 4, wherein the separated biometric information management center compares the separated biometric information received from a corresponding credit card scanner with both the part of the biometric information stored in the credit card and the biometric information separately stored in the separated biometric information management center, and transmits biometric information authentication results to a corresponding credit card company server depending on whether the two pieces of biometric information are identical with each other.

6. The biometric information recognition credit card system according to claim 1, wherein:
the separated biometric information management center stores parts of the separated biometric information of each of the credit card holders in a plurality of separated biometric information storage servers connected to the separated biometric information management center through a network; and
the separated biometric information management center compares parts of the separated biometric information received from the credit card scanner with the parts of the biometric information separately stored in the plurality of separated biometric information storage servers.

7. The biometric information recognition credit card system according to claim 6, wherein the separated biometric information management center is operated so that, at the time of comparing the biometric information, it combines the parts of the separated biometric information received from the credit card scanner into original biometric information, combines the parts of the biometric information separately stored in the plurality of separated biometric information storage servers into original biometric information, and compares the two pieces of original biometric information with each other.

8. The biometric information recognition credit card system according to claim 1, wherein:
the separated biometric information management center stores parts of the separated biometric information of each of the credit card holders in a plurality of separated biometric information storage servers connected to the separated biometric information management center through a network;
the separated biometric information management center transmits the respective parts of the separated biometric information received from the credit card scanner to the separated biometric information storage servers storing corresponding parts of the separated biometric information, respectively, of the plurality of separated biometric information storage servers;
the separated biometric information storage servers compare the parts of the separated biometric information received from the credit card scanner with the corresponding parts of the separated biometric information stored therein, respectively, and transmit the comparison results to the separated biometric information management center; and
the separated biometric information separation management center transmits biometric information authentication results, indicating that the two pieces of biometric information are identical with each other, to the credit card scanner when all comparison results from the separated biometric information storage servers indicate identities.

9. The biometric information recognition credit card system according to claim 1, wherein:
the separated biometric information management center is connected to the credit card company servers;
the separated biometric information received from the credit card scanner is transmitted to the separated biometric information management center through a corresponding credit card company server; and
the biometric information authentication results provided from the separated biometric information management center are transmitted to the credit card scanner through the credit card company server.

10. The biometric information recognition credit card system according to claim 9, wherein the credit card company server, having received the biometric information authentication results from the separated biometric information management center, combines the biometric information authentication results with data indicating whether use of the credit card is approved, and transmits the combined results to the credit card scanner.

11. A biometric information recognition credit card system, comprising:
a plurality of credit cards each storing therein credit card information including a credit card number;
a plurality of credit card scanners each having a keypad adapted to input sales details, a card information input unit adapted to read credit card information from each of the credit cards, a biometric information input unit adapted to read biometric information of each of credit card holders, a sales slip output unit adapted to output a sales slip, a communication unit adapted to transmit/receive data to/from credit card company servers, a display unit adapted to display various pieces of information, and a control unit adapted to transmit biometric information input from the biometric information input unit to a separated biometric information management center through the communication unit, to transmit sales information input through the keypad and the credit card information provided from the credit card to a corresponding credit card company server through the communication unit, and to control the sales slip output unit to output a sales slip on the basis of authentication results, provided from the credit card company server, and biometric information authentication results, provided from the separated biometric information management center;
one or more credit card company servers each transmitting data indicating whether to approve use of each of the credit cards to a corresponding credit card scanner depending on authentication results of the credit card information received from the credit card; and
the separated biometric information management center separately storing therein biometric information of each of credit card holders, comparing the biometric information received from a corresponding credit card scanner with the separately stored biometric information, and transmitting biometric information authentication results to the credit card scanner depending on whether the received biometric information is identical with the separately stored biometric information.

12. The biometric information recognition credit card system according to claim 11, wherein:
the credit cards each store therein a part of biometric information of each of the credit card holders; and
the credit card scanners each transmits a part of the biometric information stored in the credit card together with the received biometric information to the separated biometric information management center.

13. The biometric information recognition credit card system according to claim 12, wherein the separated biometric information management center separates the biometric information received from the credit card scanner, compares the separated biometric information received from a corresponding credit card scanner with both the part of the biometric information stored in the credit card and the biometric information separately stored in the separated biometric information management center, and transmits biometric information authentication results depending on whether the two pieces of biometric information are identical with each other.

14. The biometric information recognition credit card system according to claim 11, wherein:
the separated biometric information management center stores parts of the separated biometric information of each of the credit card holders in a plurality of separated biometric information storage servers connected to the separated biometric information management center through a network; and
the separated biometric information management center separates the biometric information received from the credit card scanner, and compares parts of the separated biometric information received from the credit card scanner with parts of the biometric information separately stored in the plurality of separated biometric information storage servers.

15. The biometric information recognition credit card system according to claim 11, wherein:
the separated biometric information management center is connected to a plurality of separated biometric information storage servers storing therein corresponding parts of the separated biometric information of each of the credit card holders, respectively; and
the separated biometric information management center combines parts of the biometric information, separately stored in the plurality of separated biometric information storage servers, into original biometric information, and compares the original biometric information with the biometric information received from the credit card scanner.

16. The biometric information recognition credit card system according to claim 11, wherein:
the separated biometric information management center stores parts of the separated biometric information of each of the credit card holders in a plurality of separated biometric information storage servers connected to the separated biometric information management center through a network;
the separated biometric information management center separates the biometric information received from the credit card scanner, transmits respective parts of the separated biometric information to the separated biometric information storage servers storing corresponding parts of the separated biometric information, respectively, of the plurality of separated biometric information storage servers;
the separated biometric information storage servers compare the parts of the biometric information received from the credit card scanner with the corresponding parts of the separated biometric information stored therein, respectively, and transmit the comparison results to the separated biometric information management center; and
the separated biometric information separation management center transmits biometric information authentication results, indicating that the two pieces of biometric information are identical with each other, to the credit card scanner when all comparison results from the separated biometric information storage servers indicate identities.

17. The biometric information recognition credit card system according to claim 11, wherein:
the separated biometric information management center is connected to the credit card company servers;
the biometric information received from the credit card scanner is transmitted to the separated biometric information management center through a corresponding credit card company server; and
the biometric information authentication results provided from the separated biometric information management center are transmitted to the credit card scanner through the credit card company server.

18. The biometric information recognition credit card system according to claim 17, wherein the credit card company server, having received the biometric information authentication results from the separated biometric information management center, combines the biometric information authentication results with data indicating whether use of the credit card is approved, and transmits the combined results to the credit card scanner.

19. A biometric information recognition credit card system, comprising:
a plurality of credit cards each storing therein credit card information including a credit card number;
a plurality of credit card scanners each having a keypad adapted to input sales details, a card information input unit adapted to read credit card information from each of the credit cards, a biometric information input unit adapted to read biometric information of each of credit card holders, a sales slip output unit adapted to output a sales slip, a communication unit adapted to transmit/receive data to/from credit card company servers, a display unit adapted to display various pieces of information, and a control unit adapted to receive parts of separately stored biometric information from a separated biometric information management center, to combine the parts of the biometric information into original biometric information, to compare the original biometric information with received biometric information of a credit card holder, to transmit sales information input through the keypad and the credit card information received from the credit card to a corresponding credit card company server through the communication unit when the original biometric information and the received biometric information are identical with each other, and to control the sales slip output unit to output a sales slip on the basis of authentication results provided from the credit card company server;
one or more credit card company servers each transmitting data indicating whether to approve use of each of the credit cards to a corresponding credit card scanner depending on authentication results of the credit card information received from the credit card; and
the separated biometric information management center separately storing therein biometric information of each of credit card holders, and transmitting separately stored biometric information of a corresponding credit card holder to the credit card scanner in response to a request received from the credit card scanner.

20. The biometric information recognition credit card system according to claim 19, wherein:
the credit cards each store therein a part of biometric information of each of the credit card holders; and
the credit card scanners each combine the separately stored biometric information provided from the separated biometric information management center and the part of the biometric information stored in the credit card into original biometric information.

21. A credit card scanner, comprising:
a keypad adapted to input sales details;
a card information input unit adapted to read credit card information from each of the credit cards;
a biometric information input unit adapted to read biometric information of each of credit card holders;
a sales slip output unit adapted to output a sales slip;
a communication unit adapted to transmit/receive data to/from credit card company servers;
a display unit adapted to display various pieces of information; and
a control unit adapted to separate biometric information input from the biometric information input unit and transmit separated biometric information, sales information input through the keypad, and the credit card information provided from the credit card to a corresponding credit card company server through the communication unit, and to control the sales slip output unit to output a sales slip on the basis of authentication results, provided from the credit card company server.

22. The credit card scanner according to claim 21, wherein:
the card information input unit reads a part of the biometric information of the credit card holder stored in the credit card; and
the control unit is operated so that, when the part of the biometric information stored in the credit card is identical with a corresponding part of the separated biometric information, the control unit transmits remaining parts of the separated biometric information except for the corresponding part thereof, sales information, and credit card information.
